(19) United States
(12) Patent Application Publication
(10) Pub. No.: US 2022/0062665 A1
(43) Pub. Date: Mar. 3, 2022

(54) MASK HAVING TWO INDEPENDENT CHAMBERS

(71) Applicant: Behzad Zarabi, Los Angeles, CA (US)

(72) Inventor: Behzad Zarabi, Los Angeles, CA (US)

(21) Appl. No.: 17/153,816

(22) Filed: Jan. 20, 2021

Related U.S. Application Data
(60) Provisional application No. 63/072,869, filed on Aug. 31, 2020.

(51) Int. Cl. A62B 7/10; A62B 18/08; A62B 18/02; A62B 23/02

(52) U.S. Cl. CPC A62B 7/10; A62B 23/02; A62B 18/025; A62B 18/084

(57) ABSTRACT

A face mask for covering a user's mouth is provided. The mask includes a partitioning fold that laterally separates the face mask into two breathable chambers, with one chamber comprising an upper chamber isolating the nose and a lower chamber isolating the mouth.

### CROSS-REFERENCE TO RELATED APPLICATION

This application claims the benefit of U.S. Provisional Patent Application No. 63/072,869, filed Aug. 31, 2020, which is incorporated by reference herein in its entirety.

### BACKGROUND

### Field

The present disclosure relates to the field of masks, and more particularly, but not exclusively, to personal protective face masks.

### Background

Personal protective masks, also referred to as “respirators” or “filtering face masks” have long been provided to be worn over respiratory areas of the nose and mouth of mask users. The two most common uses for these types of masks are to prevent impurities or contaminants from entering the wearer's breathing passage, and to protect others from being exposed to pathogens or other contaminates exhaled by the wearer.

The mask may be worn in environments where the air contains particles harmful to the wearer, for example, doctors working with sick patients and blue-collar workspaces where fine particulates are present (e.g., painters, mills, auto body shops, etc.). In addition, the mask may be worn in environments where there is a high risk of the wearer infecting others, for example, a sick person in a waiting room or a crowded work space.

Conventional respirators and masks provide a single shared air chamber for both inhaled and exhaled air. Unfortunately, the shared air chamber may mix inhaled and exhaled air, thereby increasing the circulation of potentially stale or contaminated air. For reasons including health and convenience, an improved design may be beneficial to address the shortcomings of conventional respirators and masks.

### SUMMARY

In an aspect of the disclosure, a face mask for covering a user's mouth is provided. The mask includes a partitioning fold that laterally separates the face mask into two breathable chambers, with one chamber comprising an upper chamber isolating the nose and a lower chamber isolating the mouth.

In another aspect of the disclosure, a method for using a face making having a partition fold is provided. The method includes controlling a tint-able window system of a vehicle is provided. The method may include controlling a light transmission state of a first layer of the window system. The method may include controlling visual imagery output of a second layer of the window system. The method may include receiving at least a portion of power from a solar energy source for controlling the first layer and the second layer.

In another aspect of the disclosure, a vehicle system having an electrically controlled tint-able window is provided. The vehicle system may include the electrically controlled fade-able window, the window comprising a first layer electrically controlled to fade between opaque states and a second layer electrically controlled to display visual imagery. The vehicle system may include a solar energy collector coupled to the window for providing at least a portion of energy for operation of the window.

### BRIEF DESCRIPTION OF THE DRAWINGS

The present disclosure is illustrated by way of example, and not by way of limitation, and may be more fully understood with reference to the following detailed description when considered in connection with the figures below.

FIGS. 1A-D are perspective views of an exemplary mask according to an embodiment of the disclosure, including an interior/rear view (FIG. 1A), top-down view (FIG. 1B), an exterior/front view (FIG. 1C), and side view (FIG. 1D).

FIGS. 2A-C are perspective views of another exemplary mask according to an embodiment of the disclosure, including an interior/rear view (FIG. 2A), a top surface view (FIG. 2B), and a bottom surface view (FIG. 2C).

FIGS. 3A-B are perspective views of another exemplary mask according to an embodiment of the disclosure, including an interior/rear view (FIG. 3A) and an exterior/front view (FIG. 3B).

FIGS. 4A-B are sample illustrations of a user wearing a mask without a partition (FIG. 4A) and an exemplary mask including a partition (FIG. 4B) according to an embodiment of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will, however, be apparent to those skilled in the art that these concepts may be practiced without these specific details. In some instances, well known structures and components are shown in block diagram form in order to avoid obscuring such concepts.

Several aspects of the mask will now be presented with reference to various apparatuses and methods. These apparatuses and methods will be described in the following detailed description and illustrated in the accompanying drawings by various blocks, modules, components, steps, processes, etc. (collectively referred to as “elements”). While the methods may be described in an ordered series of steps, it will be apparent to those skilled in the art that the methods may be practiced in any operative order and each step may be practiced in various forms that are apparent to those skilled in the art.

One concept of infection control is to slow, prevent, or stop the spread of infections within a population by reducing exposure to pathogens. By preventing passage of viral particles into the body through the eyes, nose, and mouth, infections may be reduced. To this end, masks have been one important component in combating the spread of infectious and contagious pathogens.

Meditation techniques have also shown the benefits of a breathing method for inhaling through the nose and exhaling through the mouth (or visa-versa). In some instances, slow breathing may help maintain health and well-being. The embodiments of the disclosure may be used with any breathing technique, including breathing in through the nose and exhausting through the mouth, or vice versa, or breathing in and out of either the nose or mouth, or any combination of techniques for breathing.

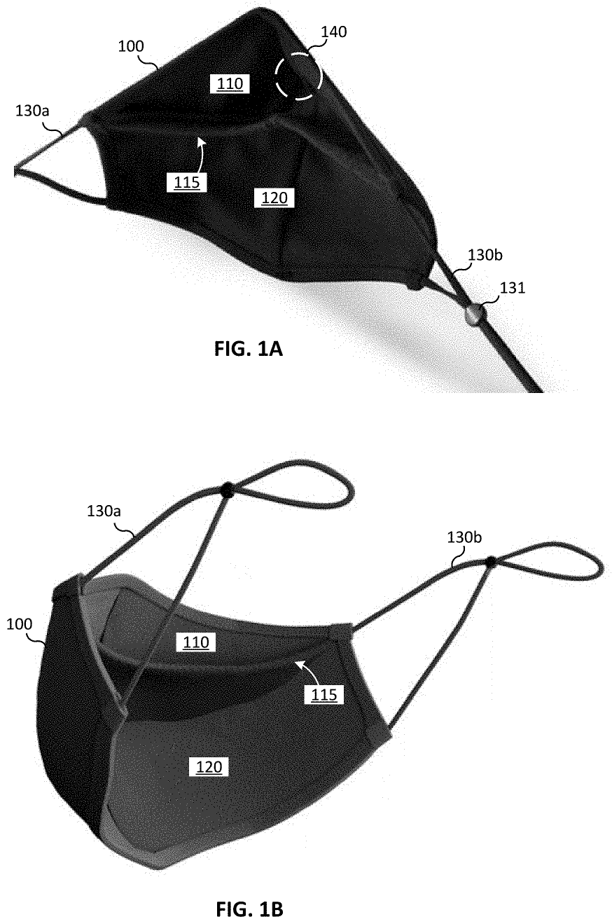

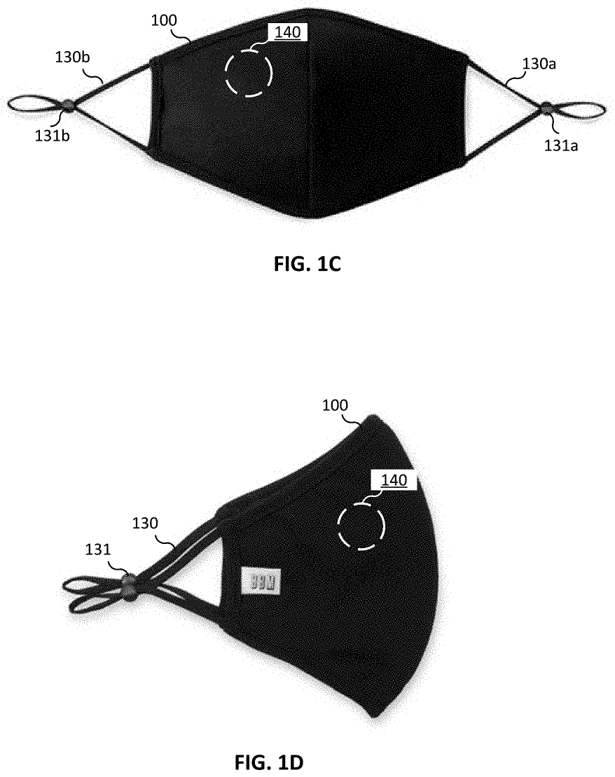

FIGS. 1A-C are perspective views of an exemplary mask 100 according to an embodiment of the disclosure, including an interior/rear view (FIG. 1A), top-down view (FIG. 1B), and an exterior/front view (FIG. 1C).

FIG. 1A shows the mask 100 with the interior/rear (which is the surface touching the face of a wearer of the mask 100). The face mask 100 may be designed to be worn over the mouth and nose of a person. In some instances, in order to allow the mask to conform to the face, the mask may be made of various materials and using various methods suitable for the purpose. The materials may include any variable of breathable or non-breathable (where a filter is provided for breathability) material. The example of FIG. 1 shows a cloth mask with elastic material and cut to form a close or tight seal around the nose and mouth of the face.

The mask 100 may include hoops or loops 130a, 130b for wearing the mask 100 by the ears (loop 130a on the left ear, loop 130b on the right ear). A hoop stopper or locker 131 may be included to adjust the hoop length for more comfortable usage. The loops 130a, 130b may be made from various materials in various configurations. While the example of FIG. 1A shows two loops designed for wearing around the ears, other embodiments may include one loop, two loops, or more, worm around the head/neck, or attached to various anchor points including points around a person's head (such as hair) or to other points such as a head band, hats, etc. for user comfort and based on design.

As illustrated, the mask 100 may include two chambers 110, 120 or enclosures, compartments, breathable areas, etc. These terms may be used interchangeably. One chamber 110, the upper chamber 110, may be designed for enclosing the user's nose. One chamber 120, the lower chamber 120, may be designed for enclosing the user's mouth. A partition 115 (or separator, divider, etc.) may isolate the two separate chambers 110, 120. With the partition 115, air and/or other particles do not pass between the two chambers 110, 120. In other embodiments where the partition 115 is semi-permeable, a low acceptable level of permeability between the chambers 110, 120 may be present to allow a low acceptable level of passage of air or other particles. With the partition 115, a person wearing the mask 100 may breathe in through one chamber 110 or 120 and exhale through a separate chamber 120 or 110 without pushing around possibly contaminated air. While the mask 100 may be suitable for all breathing techniques, in some instances it may be preferable for the person to breathe in through the top chamber 110 (through the nose) and exhale through the bottom chamber 120 (through the mouth).

One advantage of the isolated chamber design may include preventing fogging of eyeglasses. In some instances, with designs lacking the partition (e.g., traditional facemasks), the air in the mask warms up and rises or leaks above the mask thereby causing eyeglasses to fog. In the disclosed embodiments, when the user breathes out of their mouth, the warm exhausted breath is isolated to the bottom chamber away from the user's eyeglass. In this manner, the warm air does not contact the eyeglass and the mask design prevents the user's eyeglasses from fogging up. Another advantage of the disclosed embodiments (when the user breathes in from the nose and out through the mouth) may include isolating the exhaust breathe down and away, so that any contaminated air is directed away from other near-by people. For example, some viruses are transmitted through larger or heavier water droplets that fall to the drop as soon as they're emitted from a person. Because the disclosed embodiments channel any such droplets down and away from others, the designs beneficially prevent transmission of pathogens.

In some embodiments, the two chambers may have different designs. For example, the top chamber may have a more impermeable design or material. The bottom chamber may have a more porous design or material. In some embodiments, the two chambers may be similarly designed, with similar materials used. A similar design may provide easier manufacturing methods. If different chamber designs are used, the inhale chamber (or exhale chamber) may be designed with more (or less) stringent requirements.

Optionally, the mask 100 may include one or more filters 140. In some embodiments, the mask 100 may include no filters. In other embodiments, the mask 100 may include multiple filters 140. The filter may provide any level of filtration based on design or user preference. For example, the filter may provide particulate filtration and/or may be impermeable to fluids/liquids. In modern times with pandemic outbreaks of respiratory viruses, filters impermeable to fluids/liquids may be preferable to reduce the spread of pathogens contained in aerosols, droplets, moisture, etc. In some embodiments, the mask 100 may include a filter usage indicator showing the usage or capacity of the filter.

In the illustrated example, one filter 140 is shown in the top chamber 110 (chamber isolating the nose). The filter 140 may be integrated into an interior of the fabric such that the filter 140 is not clearly visible on the outside surface. This design with a filter 140 on the interior of the mask 100 (e.g., between two fabric layers) may provide the benefit of a seamless-looking mask 100 without the distracting look of a protruding filter. In other embodiments, the filter 140 may be located in the inside or outside of the mask.

In other embodiments, there may be multiple filters 140 located in any area of the mask 100 as suitable for design and preference. For example, the top chamber 110 may include multiple filters to provide better filtration and ease of inhalation for the user. In another example, there may be a filter in the partition 115 to filter particulates between the chambers 110, 120. In yet another example, there may be filters in the bottom chamber 120 to suit various breathing styles or techniques.

FIG. 1B shows a top-down view of the mask 100. A digital line is shown representing the partition 115 for clarity. The view shows the mask 100 may be designed to contour around a person's face with the top chamber 110 covering the nose and bottom chamber 120 covering the mouth area. The left loop 130a is worn around the left ear to secure the mask to the face. The right loop 130b is worn around the right ear.

FIG. 1C shows an exterior or front view of the mask 100. The front of the mask 100 may look uniform without showing a filter 140 or even the contour of the filter 140. The filter 140 may be embedded inside the mask 100 to provide better aesthetics or fashion for the mask 100. Because some users may prefer a seamless or uniform-looking mask 100, the filter 140 may be embedded inside layers of the mask 100 in some embodiments. Some embodiments may not use filters 140 so that those embodiments may be seamless without needing additional design considerations. The mask 100 may include hoops 130a, 130b to wear around the user's ears with locks 131a, 131b for adjusting the hoops.

FIG. 1D shows a folded side view of the mask 100. Because some embodiments may be flexible, the mask may be folder or otherwise compacted for ease of transportation. FIG. 1D shows the mask 100 including the optional filter 140 and hoops 130 with the hoop lock 131.

One skilled in the art will recognize that various design choices may provide alternative embodiments for the masks.

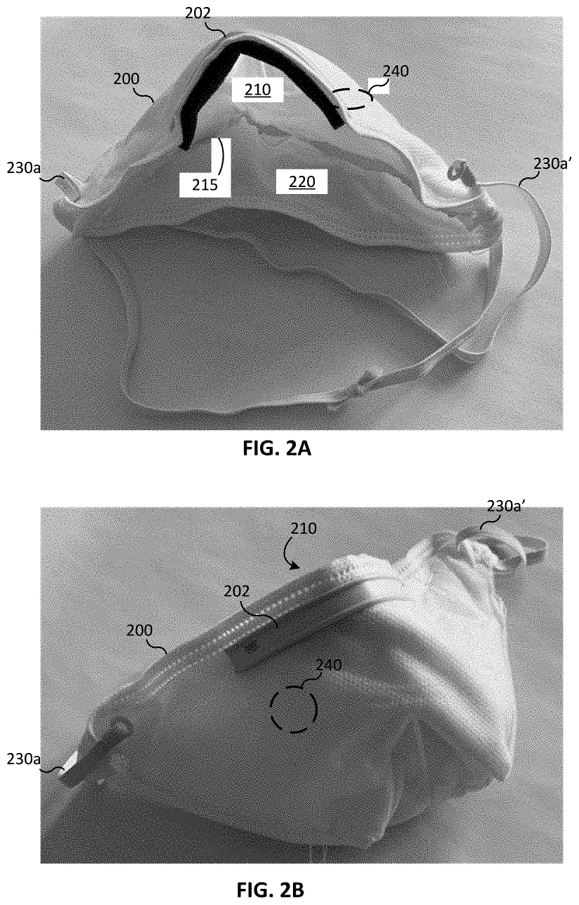

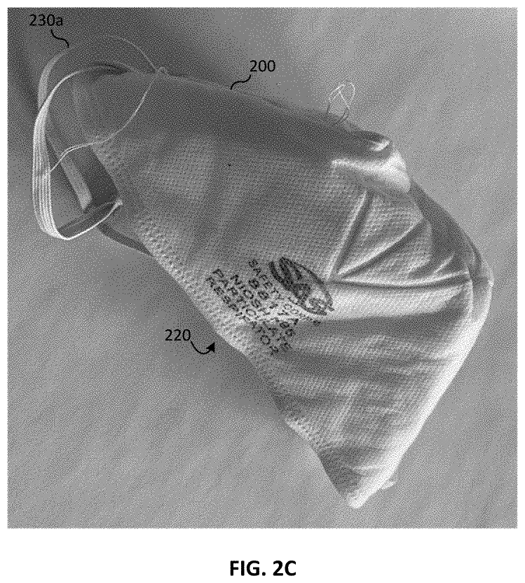

FIGS. 2A-C are perspective views of another exemplary mask according to an embodiment of the disclosure, including an interior/rear view (FIG. 2A), a top surface view (FIG. 2B), and a bottom surface view (FIG. 2C).

The example of FIG. 2A shows a mask 200 having a rigid nose band/clasp 202 for ensuring a seal around the user's face and nose. In some examples, the band/clasp 2020 may be elastic or other suitable material. In some embodiments, the nose clasp 202 may fold around a cushioning material to provide comfort and a better seal against the nose and face. As illustrated in FIG. 2A, the mask may include a partition 215 that divides the mask into two chambers 210, 220, including a top chamber 210 and a bottom chamber 220. The top chamber 210 isolates the nose area while the bottom chamber 220 isolates the mouth area. In the example of FIG. 2A, the mask 200 may include a single band 230a for securing the mask 200 to the face. The band 230a may pass through small loops on both sides of the mask 200 so that the single band forms two apparent bands for securing against a person's face. A filter 240 may be embedded into the mask 200. For example, the filter 240 may lie between an outer and an inner layer of the material of the mask 200. In some embodiments, the mask 200 may include no filters or more than one filter 240. The mask may include one or more layers based on design or preference. An “interior” layer (layer touching user's face) may be provided next to a middle layer (sandwiched between the “interior” layer and an outer layer). The outer layer is the outwardly visible layer. There may be any number of interior layers.

FIG. 2B shows a top surface view of the mask 200 showing the nose band/clasp 202 and the band 230a, 230a′ for wearing by the user. A filter 240 may be embedded in the mask 200 layers. The top chamber 210 (not visible) is adjacent to/contiguous with the top surface.

FIG. 2C shows a bottom surface view of the mask 200 showing the loop 230a and bottom chamber 220 (not visible) is adjacent to/contiguous with the bottom surface.

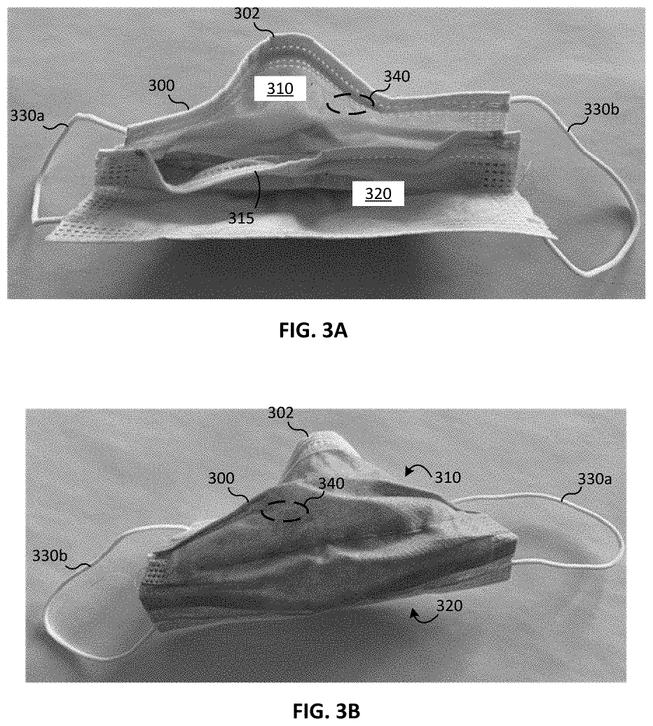

FIGS. 3A-B are perspective views of another exemplary mask 300 according to an embodiment of the disclosure, including an interior/rear view (FIG. 3A) and an exterior/front view (FIG. 3B).

FIG. 3A shows the interior/rear view of the mask 300. The example mask 300 may be pleated with a material impermeable to liquids/fluids. This type of mask may be more suitable for high-risk areas such as medical facilities (hospitals, operating rooms, etc.), etc.

The mask 300 is shown with a nose band/clasp 302 for better fit around the user's nose and face. The mask 300 includes a left loop 330a and right loop 330b worn around the ears to secure the mask 300 to the face. The partition 315 isolates the top chamber 310 from the bottom chamber 320. One or more optional filters 340 may be included in the mask 300. The example filter 340 is shown in the top chamber 310, e.g., for user's breathing in through the nose.

FIG. 3B shows the exterior/front view of the mask 300. The front view shows the mask having the nose band/clasp 302, embedded filter 340, top chamber 310 (not visible), bottom chamber 320 (not visible), left loop 330a, and right loop 330b.

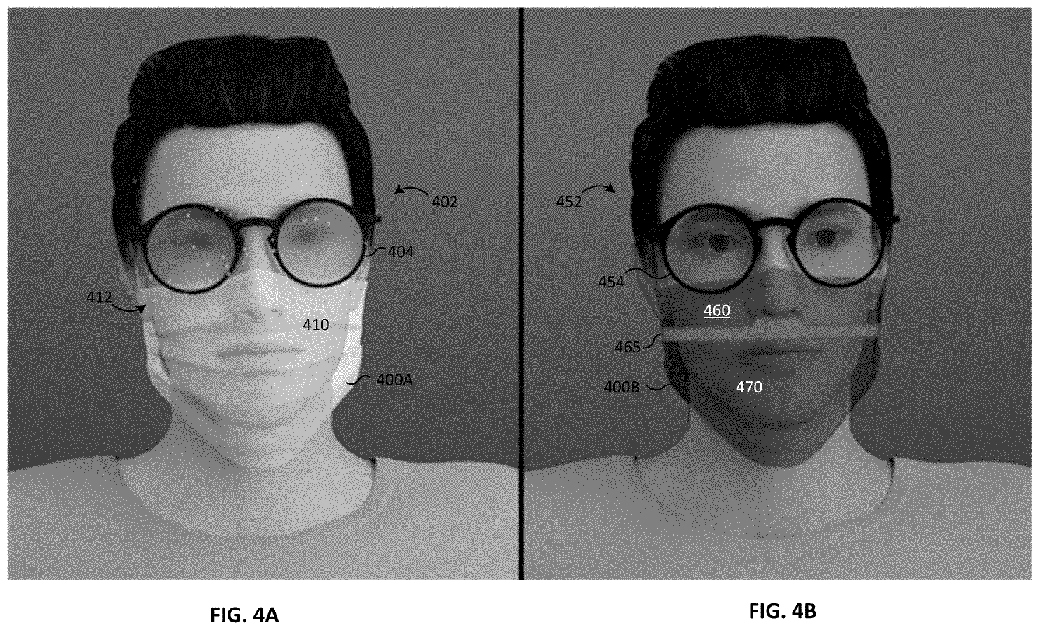

FIGS. 4A-B are sample illustrations of a user wearing a mask without a partition (FIG. 4A) and an exemplary mask including a partition (FIG. 4B) according to an embodiment of the disclosure.

In FIG. 4A, the illustration shows the effect of wearing and using a mask 400A without a partition. Because there is no partition, as the user 402 breathes in and breathes out, the air collects inside the area covered by the mask 410. Moisture 412 (or particulates or contaminants, etc.) collect in the covered area 410 and may spread or rise into the upper face area of the user 402. When the user 402 wears glasses 404, the moisture 412 or contaminants may cause the glasses to fog. Because there is no partition, regardless of whether the user 402 breathes out through the hose or mouth, the moisture 412 spreads through the entire area 410 and eventually spreads to the upper face.

In FIG. 4A, the illustration shows the effect of wearing and using a mask 400B including a partition according to any of the embodiments such as those description above with reference to FIGS. 1A-1D or FIGS. 2A-2C. Because there a separating partition 465, as the user 452 breathes in and breathes out, the air may collect only in one of the chambers 460, 470. When the user breathes out through the mouth, the moisture may collect only in the chamber 470 including the mouth. The partition 465 prevents the air and moisture from entering the upper chamber 460 and prevents the air and moisture from rising into the user's upper face area. As illustrated, the user's 452 glasses 454 remain clear without condensation from air escaping the mask.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

It is understood that the specific order or hierarchy of steps in the processes and embodiments disclosed are illustrations of exemplary approaches. Based upon design preferences, it is understood that the specific order or hierarchy of steps in the processes or design layouts may be rearranged. Further, some steps may be combined or omitted. Any accompanying method claims may present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A face mask for covering a user's mouth, the mask comprising a partitioning fold that laterally separates the face mask into two breathable chambers, with one chamber comprising an upper chamber isolating the nose and a lower chamber isolating the mouth.

2. The face mask of claim 1, wherein the partitioning fold isolates air between the two breathable chambers such that air from one chamber does not migrate to the other chamber.

3. The face mask of claim 2, wherein the partitioning fold comprising one of a semi-permeable or impermeable membrane.

4. The face mask of claim 1, wherein the upper chamber comprises at least one filter for selectively removing particulates from the air.

5. The face mask of claim 1, further comprising at least one elastic band attached at opposing lateral ends of the face mask for securing the face mask to the user's face.

6. The face mask of claim 1, wherein the face mask comprises at least one of a fabric, mesh, or natural or synthetic fiber material.

7. The face mask of claim 1, wherein the face mask comprises one of a partial-face mask covering the nose and mouth or a full-face mask covering the eyes, nose, and mouth.

8. A method for using a face mask comprising a partitioning fold, the method comprising:
providing a face mask comprising the partitioning fold that laterally separates the face mask into two breathable chambers;
inhaling through a first of the two breathable chambers; and
exhaling through a second of the two breathable chambers;

9. The method of claim 8, further comprising inhaling through the nose and exhaling through the mouth.

10. The method of claim 8, further comprising inhaling through the mouth and exhaling through the nose.
